(19) United States
(12) Patent Application Publication
(10) Pub. No.: US 2026/0077497 A1
(43) Pub. Date: Mar. 19, 2026

(54) HUMAN-ROBOT COLLABORATION CONTROL SYSTEM

(71) Applicant: Intel Corporation, Santa Clara, CA (US)

(72) Inventors: Rodrigo Aldana Lopez, Zapopan (MX); Leobardo Campos Macias, Guadalajara (MX); David Gomez Gutierrez, Tlaquepaque (MX); Edgar Macias Garcia, Zapopan (MX); Julio Zamora Esquivel, West Sacramento, CA (US)

(21) Appl. No.: 19/342,104

(22) Filed: Sep. 26, 2025

(51) Int. Cl. B25J 9/16; B25J 19/02; B62D 57/032

(52) U.S. Cl. CPC B25J 9/1664; B25J 9/161; B25J 9/1653; B25J 19/023; B62D 57/032

(57) ABSTRACT

A control system for human-robot collaboration, including: a passive reactive control path implemented through a virtual damping system and configured to generate reactive control signals in response to human-applied interaction inputs; a predictive control path configured to generate predictive control signals based on predicted human performance objective inferred online from measured contact wrenches; and a signal blending component configured to combine the reactive control signals and the predictive control signals, wherein the predictive control signals are bounded in magnitude such that passivity of the reactive control path is preserved and stability of closed-loop human-robot interaction is maintained during collaboration.

### BACKGROUND

Robotic systems are increasingly deployed in industrial environments, such as semiconductor fabrication facilities, to work in collaboration with humans. A common scenario in these settings is physical collaboration, where a robot and a human jointly hold and transport an object.

Current control strategies for human-robot collaboration tasks are predominantly reactive, with the robot measuring contact forces and compliantly following the human's motion. While this ensures safety and prevents excessive resistance, it confines the robot to a passive follower role, placing the majority of the physical effort on the human and relying on trajectory planning. The lack of predictive assistance is a significant technical challenge, as the robot is unable to anticipate human intent, provide proactive task support, or optimize collaborative movements. These limitations result in increased human fatigue, slower task execution, and reduced coordination efficiency, especially when handling large, heavy, or awkwardly shaped objects, which is a frequent requirement in manufacturing and assembly contexts.

There is a need for control architectures that combine safety, adaptability, and predictive capability in physical human-robot collaboration.

### BRIEF DESCRIPTION OF THE FIGURES

FIG. 1 illustrates an example of physical human-robot collaboration, according to aspects of the present disclosure.

FIG. 2 illustrates a control system for human-robot collaboration, according to aspects of the present disclosure.

FIG. 3 illustrates an object during human-robot collaboration, according to aspects of the present disclosure.

FIG. 4 illustrates a virtual damper system in human-robot collaboration, according to aspects of the present disclosure.

FIG. 5 illustrates an object during collaboration between a plurality of humans and robots, according to aspects of the present disclosure.

FIG. 6 illustrates a computing device, according to aspects of the disclosure.

### DETAILED DESCRIPTION

The following description sets forth exemplary aspects of the present disclosure. It should be recognized, however, that such a description is not intended as a limitation on the scope of the present disclosure. Rather, the description also encompasses combinations and modifications to those exemplary aspects described herein.

### I. Overview

In many industrial environments, robots are increasingly deployed to work alongside humans rather than replace them. Human involvement remains important because humans contribute unique cognitive capabilities such as situational awareness, adaptive problem-solving, and rapid decision-making under unforeseen conditions. In contrast, fully automated robotic systems often lack flexibility in unstructured environments and may require extensive reprogramming or retraining when new tasks arise. Human-robot collaboration combines the physical precision, strength, and endurance of robots with the perceptual and decision-making abilities of humans.

A representative example can be found in semiconductor manufacturing facilities, where robots automate repetitive or hazardous operations, such as transporting wafer cassettes, while humans oversee complex procedures and manage unexpected process variations. In such settings, physical collaboration, where a human and a robot simultaneously hold and move the same object, offers a practical mode of cooperation. This allows robots to provide stability and load sharing while humans guide task execution and adapt to dynamic conditions.

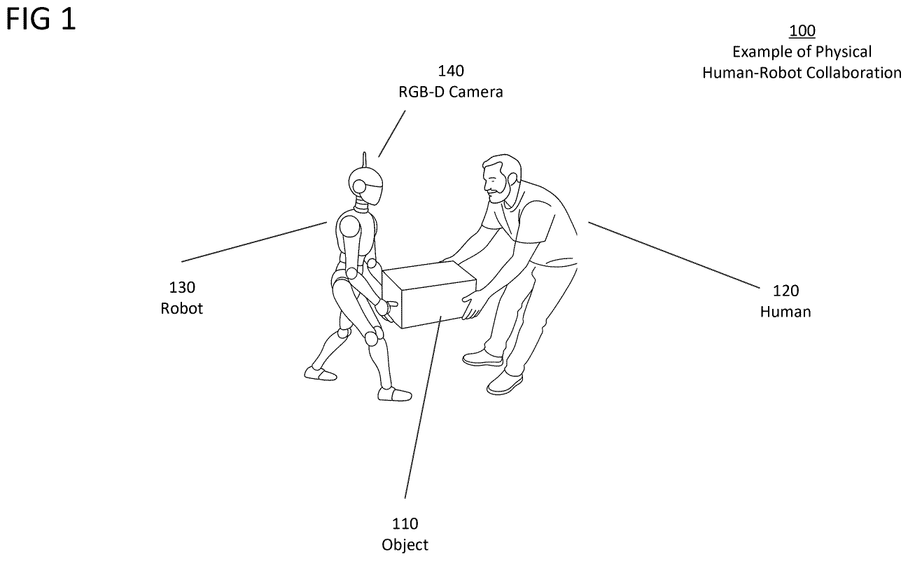

FIG. 1 illustrates an example of physical human-robot collaboration 100, with a human 120 and a robot 130 jointly carrying an object 110. The robot 130 provides physical support while the human 120 directs the movement. An RGB-D (red green blue-depth) camera 140 may be included to provide additional perception capabilities, such as estimating object pose, monitoring human intent, or improving motion coordination. The RGB-D camera 140 continuously captures depth and color information to support spatial target inference. The computer vision processing analyzes human behavioral cues such as gaze direction, postural orientation, and reaching patterns to estimate probable object destinations within the collaborative workspace. This visual analysis generates inferred spatial targets that are incorporated into the object state for predictive assistance computation.

In this example, the robot 130 may employ force or torque sensing at its manipulators to measure interaction forces and ensure compliant motion, thereby maintaining safety. The human 120 determines the pace and direction of movement, while the robot 130 contributes stabilizing and load-sharing forces. This configuration represents collaborative industrial tasks in which both partners share responsibility for achieving the manipulation objective.

### II. Control System for Human-Robot Collaboration

Aspects of the present disclosure provide a control architecture that combines a passive, kinetic energy-dissipative reactive controller with a bounded predictive assistance component configured to infer a human performance objective online from wrench-twist data. The reactive control path ensures passivity, stability, and compliance, while the predictive control path contributes anticipatory support without destabilizing the closed-loop system. Together, these paths enable safe and adaptive physical human-robot co-manipulation across multiple contact points and robotic effectors.

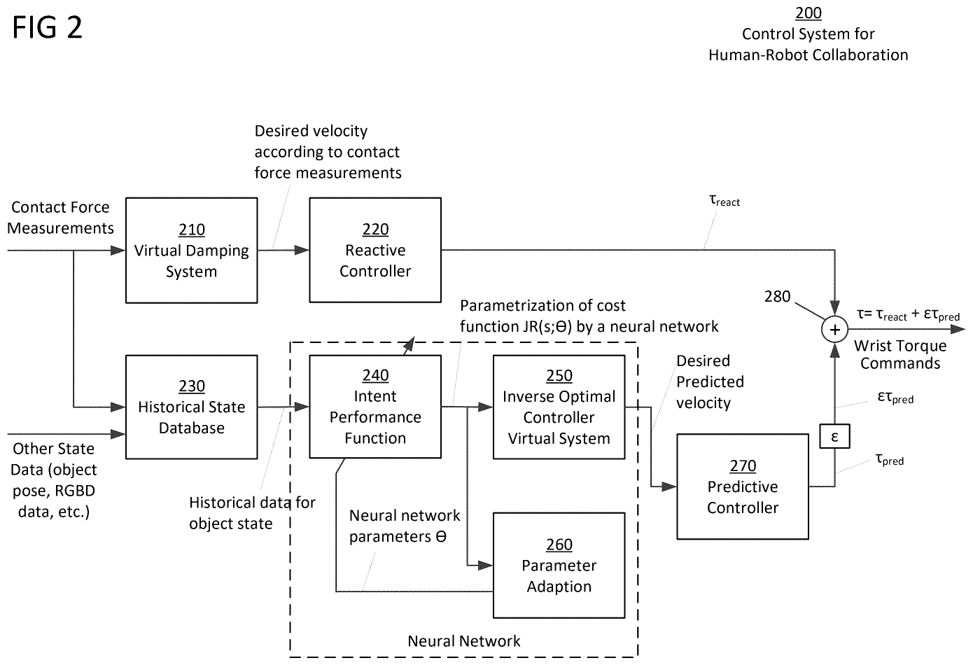

FIG. 2 illustrates a control system 200 for human-robot collaboration, according to aspects of the present disclosure.

The control system 200 integrates a passive reactive control path and a predictive control path learned from human-robot interaction data. The control system 200 preserves the passivity of the passive reactive control path while augmenting it with bounded predictive signals that provide proactive assistance.

In the figure, the passive reactive control path (upper branch) implements compliance through a virtual damping system 210 that generates reactive motion commands τ_{react} in response to measured interaction forces. The predictive control path (lower branch) constructs and updates a model of human intent from historical and current state data, estimates the associated performance objective, and generates predictive motion commands τ_{pred} to assist task completion. A signal blending component 280 combines the reactive and predictive motion commands to produce a final control input to the robot.

### A. Reactive Controller 220

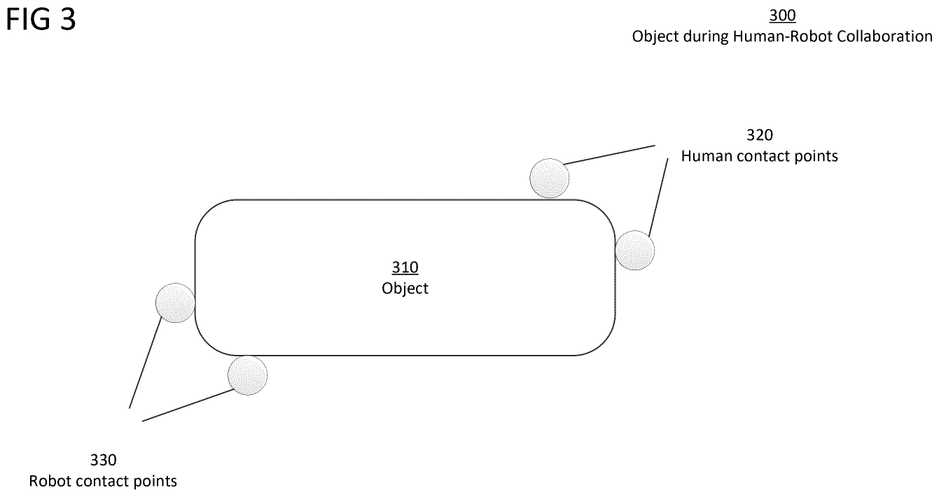

The reactive controller 220, as illustrated in FIG. 2 and further detailed with respect to FIG. 3, is responsible for generating the robot's reactive motion commands τ_{react} based exclusively on the current contact force measurements at the robot's contact points 330 with the object 310. In the control system 200 of FIG. 2, the reactive controller 220 receives input from the virtual damping system 210, which models a compliant mechanical damper at the object level. This configuration ensures that the robot's actions remain passive and kinetic energy-dissipative, following the human's movements with controlled compliance.

In the scenario depicted in FIG. 3, the object 310 is manipulated by the robot 130 equipped with at least two grippers, which serve as robot contact points 330 with the object 310. Each gripper is fitted with force-torque sensors, enabling the robot 130 to measure the forces and torques applied at these contact points 330.

The reactive controller 220 processes the scalar contact force measurements from the robot's wrists to compute the total force vector F_{c} and torque T_{c} imparted to the object 310. These quantities are determined using standard techniques, leveraging the known positions and orientations of the robot's wrists. The combination of force and torque, denoted as W_{c}=(F_{c}, T_{c}), is referred to as the contact wrench.

To translate the contact wrench W_{c} into actionable robot commands, the reactive controller 220 employs a Cartesian admittance model. The desired object twist Vₐ=(Vₐ, ωₐ), which includes both linear and angular velocity components, is computed according to the following relation:

$${M}_{a} {\dot{V}}_{a} + {D}_{a} {V}_{a} = {W}_{c} , \qquad ( Equation 1 )$$

where Mₐ and Dₐ are positive definite matrices representing a virtual inertia and damping. This formulation ensures that the robot's response to external forces is compliant and dissipative, mimicking the behavior of a mechanical damper.

For each wrist i∈{1,2} of the robot 130, the desired twist command vid is obtained by transforming the object-level twist Vₐ into the local reference frame of the wrist using a spatial transform Xᵢ:

$${v}_{i , d} = {X}_{i} {V}_{a} . \qquad ( Equation 2 )$$

If the robot's control interface supports direct velocity commands, v_{i,d} is used as the linear and angular velocity command for the corresponding end effector 330. In cases where only torque commands are available, the reactive controller 220 generates the required torque using the following expression:

$${τ}_{reactive} = {J}_{i}^{T} K ( {v}_{i} - {v}_{i , d} ) + {τ}_{g} . \qquad ( Equation 3 )$$

Here, Jᵢ is the Jacobian matrix for the end effector, K is a gain matrix, vᵢ is the current velocity of the end effector 330, and τ_{g} is the standard gravity compensating torque.

Through this process, the reactive controller 220 ensures that the robot's motion is governed by the measured interaction forces, providing compliant support to the human 120 while maintaining system passivity and stability. The architecture enables the robot 130 to resist motion proportionally to velocity, while remaining responsive to human-applied inputs at robot contact points 320, thereby facilitating safe and effective physical human-robot collaboration.

### B. Virtual Damping System 210

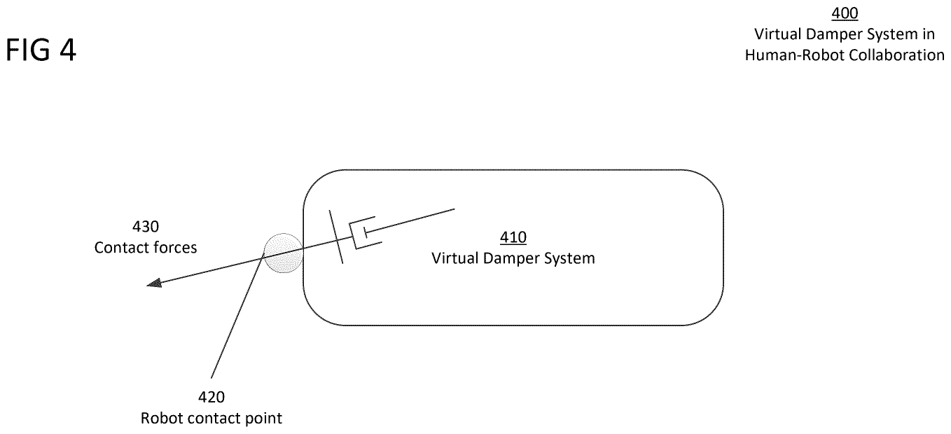

The virtual damping system 210, as shown in FIG. 2 and further illustrated in FIG. 4, implements a software model of a mechanical damper that is connected to the object 110 during human-robot collaboration. This virtual damping system 210 utilizes measurements of contact force 430 at the robot's contact point 420 to generate a compliant motion response. The arrow in FIG. 4 represents the contact forces 430 applied by the human 120, and which are processed by the virtual damping system 210.

A primary function of the virtual damping system 210 is to resist motion proportionally to velocity, thereby simulating the effect of mechanical damping between the robot 130 and the object 110. This is achieved by producing velocity commands that induce a sense of viscosity in the object's motion from the human's perspective. The resulting compliant velocity response allows both the human 120 and the robot 130 to perceive a dissipative coupling to the object 110. The object 110 resists motion but can be moved in any direction by the human 120.

The described approach may use fixed Cartesian admittance parameters. However, alternative implementations are possible. For example, an adaptive impedance formulation may be employed, wherein the damping is modulated based on the magnitude of the interaction force or the estimated human effort. Another variant is anisotropic virtual damping, which reduces resistance along directions of likely human intent while maintaining higher resistance in orthogonal directions to enhance stability. Additionally, the reactive controller 220 may utilize a passivity-based formulation to guarantee kinetic energy dissipation regardless of parameter tuning, or leverage model-based inverse dynamics for improved tracking of the admittance-generated trajectories.

In summary, the virtual damping system 210 forms a compliant foundation of the control architecture, ensuring that the robot's motion remains safe, stable, and responsive to human-applied forces.

### C. Historical State Database 230 and Intent Performance Function 240

The historical state database 230 and the intent performance function 240, as depicted in FIG. 2, play a central role in enabling predictive assistance within the control system 200 for human-robot collaboration.

The historical state database 230 is responsible for storing past measurements of the object's state during collaborative manipulation. This includes data such as positions, velocities, and forces experienced by the object 110 as it is manipulated by the human 120 and the robot 130. In addition to these physical measurements, the historical state database 230 may also incorporate processed data from one or more RGB-D sensors, which can provide enhanced perception of the object's pose and the human's actions. By accumulating this historical information, the historical state database 230 supplies the necessary context to recognize motion patterns and infer the human's intent over time.

The intent performance function 240 utilizes both current and historical state information from the historical state database 230 to evaluate how well the ongoing motion aligns with the human's inferred task objective. This intent performance function processes the collected data and produces a numerical score or metric that reflects the degree of alignment between the observed actions and the predicted human intent. The intent performance function 240 processes the enhanced state information, which includes not only physical measurements but also inferred spatial targets derived from computer vision analysis. By incorporating these visual cues about human intent, the intent performance function 240 can more accurately assess alignment between observed actions and predicted objectives, enabling more effective predictive assistance. In one implementation, the intent performance function 240 is parameterized by a neural network, which is trained to map state and force histories to intent scores. However, alternative approaches may be employed, such as Gaussian processes, radial basis function approximators, or symbolic regression, to maintain interpretability or to accommodate scenarios with limited data.

Furthermore, the historical state database 230 and the intent performance function 240 may be designed to operate with various forms of data representation. Instead of storing raw state and force trajectories, the historical state database 230 may be structured into high-level motion primitives or latent embeddings learned from prior interaction episodes, thereby reducing storage requirements and accelerating intent inference. The models used for the intent performance function 240 may also be configured to incorporate additional sensory inputs, such as vision, proprioception, or external tracking systems, to improve the accuracy and robustness of intent estimation.

Together, the historical state database 230 and the intent performance function 240 enable the control system 200 to continuously learn and adapt to the human operator's objectives, providing the foundation for predictive control and proactive assistance in physical human-robot collaboration.

### D. Inverse Optimal Controller Virtual System 250

The inverse optimal controller virtual system 250, as shown in FIG. 2, is responsible for estimating the underlying cost or reward function that the human 120 is implicitly optimizing during collaborative manipulation with the robot 130. This system 250 operates by analyzing the outputs of the intent performance function 240, which provides a numerical assessment of how well the current and historical motions align with the human's inferred task objective.

Through an inverse optimal control process, the inverse optimal controller virtual system 250 interprets the observed behavior, namely, the sequence of actions and responses recorded in the historical state database 230, and estimates the objective function that best explains the human's decision-making and control strategy. By doing so, the inverse optimal controller virtual system 250 transforms raw behavioral data into a formalized performance index, which can then be used to guide predictive assistance and improve the robot's support of the human's intent.

The implementation of the inverse optimal controller virtual system 250 may utilize various algorithms to recover the human's reward function. For example, inverse reinforcement learning (IRL) techniques such as maximum entropy IRL or Bayesian IRL may be employed to probabilistically model multiple possible intents, which is especially valuable in scenarios where the human's goals are ambiguous or may change over time. These approaches allow the inverse optimal controller virtual system 250 to maintain flexibility and adapt to different users or task conditions.

Additionally, the parameter adaptation process within the inverse optimal controller virtual system 250 may be configured in different ways. While continuous gradient-based updates are one option, alternative methods, such as expectation-maximization routines over sliding windows of data or batch updates triggered by significant behavioral changes, may be used to refine the inferred performance index. This adaptability ensures that the inverse optimal controller virtual system 250 remains responsive to evolving human strategies and maintains accurate intent inference throughout the collaboration.

In summary, the inverse optimal controller virtual system 250 provides a link between observed human behavior and the predictive control path, enabling the control system 200 to proactively assist the human 120 by optimizing actions in accordance with the inferred objective.

### E. Parameter Adaptation 260

The parameter adaptation 260, as illustrated in FIG. 2, is responsible for continuously updating the parameters of the intent performance function 240 based on new observations collected during ongoing human-robot collaboration. As the robot 130 interacts with the human 120 and the object 110, fresh data regarding positions, velocities, forces, and other relevant states are accumulated in the historical state database 230.

Parameter adaptation 260 utilizes these new observations to refine the predictive model that estimates human intent. By adjusting the parameters of the intent performance function 240, such as the weights of a neural network or coefficients in alternative models, the control system 200 ensures that the predictive control path remains accurate and responsive to the human's evolving strategies and preferences. This continuous learning process allows the control system 200 to improve its ability to anticipate and support the human's objectives over time, even as task conditions or user behaviors change.

### F. Predictive Controller 270

The predictive controller 270, as depicted in FIG. 2, is designed to actively assist the human 120 by computing predicted velocity commands that improve task performance from the human's perspective. Unlike purely reactive control, which follows the human's applied forces, the predictive controller 270 leverages the inferred objective, estimated by the intent performance function 240 and the inverse optimal controller virtual system 250, to anticipate and proactively support the human's intent.

The state s of the object during human-robot collaboration comprises multiple components that characterize both the current physical state and the inferred human intent. Specifically, the state s includes the pose of the object and its rate of change, historical trajectories of these physical variables, measured contact forces and wrenches, and inferred spatial targets derived from computer vision analysis of the collaborative workspace.

The inferred spatial targets are computed by analyzing visual cues captured by one or more RGB-D cameras 140 positioned to observe the human operator 120, the object 110, and the surrounding workspace. A computer vision module processes visual information including human gaze direction, body positioning, hand orientation, and workspace geometry to identify probable destination locations or intermediate waypoints toward which the human intends to move the object. These spatial targets are represented as discrete coordinate locations or continuous probability distributions over the workspace, and are dynamically updated as new visual information becomes available.

The integration of inferred spatial targets into the state s enables the neural performance function J(s; θ) to account for both the current physical dynamics and the anticipated future trajectory when computing the gradient ∇ᵥJ(s) for predictive assistance. This allows the predictive controller 270 to generate assistance commands that not only respond to current forces and motions, but also proactively support movement toward the most likely intended destinations identified through computer vision analysis.

The predictive controller 270 operates under the assumption that the human's actions are directed toward maximizing a performance function J(s), which depends on the state of the object 110, including its pose, rate of change, and potentially a history of these variables. The human's desired twist command at time t, denoted Vₕ(t), can be modeled as a gradient ascent on J(s):

$${V}_{h} ( t ) = {V}_{h} ( t - Δ t ) + Δ t α {∇}_{v} J ( s ) , \qquad ( Equation 4 )$$

where α is a scaling factor and ∇ᵥJ(s) is the gradient of the performance function with respect to the twist command. As Δt→0, the wrench imposed by the human, Wₕ(t), is approximately:

$${W}_{h} ( t ) = \frac{d {V}_{h}}{dt} \approx α {∇}_{v} J ( s ) . \qquad ( Equation 5 )$$

To estimate J(s), the predictive controller 270 utilizes a neural network parameterization J_{R}(s; θ), where θ represents the network parameters. The last layer of the network is a scalar ReLU neuron, ensuring the output is positive. The intent prediction cost function at time t is defined as:

$$C ( θ ; t ) = {‖ {W}_{h} ( t ) - α {∇}_{v} {J}_{R} ( s ( t ) ; θ ) ‖}^{2} . \qquad ( Equation 6 )$$

Automatic differentiation is used to compute ∇ᵥJ_{R}(s(t); θ) and the gradient ∇_{θ}C(θ; t) for parameter updates. The historical error over-sampling instants tₖ≤t is given by:

$${C}_{H I S T} ( θ , t ) = {\sum }_{k = 1}^{K} C ( θ ; {t}_{k} ) \qquad ( Equation 7 )$$

Parameter updates are performed as:

$$θ ( t ) = θ ( t - Δ t ) + Δ {tl}_{r} {∇}_{θ} {C}_{H I S T} ( θ , t ) , \qquad ( Equation 8 )$$

where lᵣ>0 is the learning rate, and as Δₜ→0:

$$\dot{θ} = {l}_{r} {∇}_{θ} {C}_{H I S T} ( θ , t ) . \qquad ( Equation 9 )$$

The robot's predictive twist command is then computed to maximize the same performance index as the human:

$${\dot{V}}_{pred} = α {∇}_{v} J ( s ) . \qquad ( Equation 10 )$$

Hence, the final form of the predictive controller 270 takes the form of:

$${τ}_{pred} = {J}_{i}^{T} {K}_{pred} ( {v}_{i} - {X}_{i} {V}_{pred} ) \\ {\dot{V}}_{pred} = α {∇}_{v} J ( s ; θ ) \\ \dot{θ} = {l}_{r} {∇}_{θ} {C}_{HIST} ( θ , t ) \\ {C}_{HIST} ( θ , t ) = {\sum }_{k = 1}^{K} {‖ {W}_{h} ( {t}_{k} ) - α {∇}_{v} {J}_{R} ( s ( {t}_{k} ) ; θ ) ‖}^{2} \qquad ( Equation 11 )$$

Here, the equation for C_{HIST}(θ, t) is generated by the intent performance function 240, \dot{V}_{pred} dynamics are generated by the inverse optimal controller virtual system 250, \grave{θ} dynamics are generated by the parameter adaptation 260, and the predictive torque command τ_{pred} is generated by the predictive controller 270.

The predictive controller 270 thus generates a predictive torque command τ_{pred} that, when combined with the reactive torque command τ_{reactive}, forms the total control action:

$$τ = {τ}_{react} + {ϵτ}_{pred} , \qquad ( Equation 12 )$$

where ϵ>0 is a design parameter that determines the relative influence of the predictive action.

While the predictive controller 270 is described here as a gradient ascent on the learned cost function, alternative implementations are possible. For example, model predictive control (MPC) may be used if a predictive model of the human-robot-object dynamics is available, enabling explicit constraint handling and the incorporation of predefined waypoints or workspace limits. In scenarios with discrete, known targets, the predictive controller 270 can operate as a hybrid decision-making system, inferring the human's likely target online through Bayesian filtering or maximum likelihood estimation and planning robot assistance to align with the most probable goal.

In summary, the predictive controller 270 provides active, anticipatory support to the human operator 120, enhancing collaboration by optimizing robot actions in accordance with the inferred human objective.

### G. Signal Blending Component 280

The signal blending component 280, as shown in FIG. 2, is responsible for combining the velocity commands generated by the reactive controller 220 and the predictive controller 270. After both the reactive and predictive control paths independently compute their respective velocity commands based on measured interaction forces and inferred human intent, the signal blending component 280 merges these commands to produce a unified control input for the robot 130.

This blending process may involve applying a scaling factor e to the predictive command to ensure that the overall system remains stable and that the passivity of the reactive control path is preserved. The resulting blended command can be provided directly as a velocity input to the robot's end effectors or, if required by the robot's control interface, converted into a torque command for execution.

By integrating the outputs of both control paths, the signal blending component 280 enables the robot 130 to provide compliant, safe, and anticipatory assistance to the human 120, ensuring that the benefits of both reactive compliance and predictive support are realized during collaborative manipulation.

### I. Safety Enforcement

The control system 200 is inherently safe because the reactive controller 220 provides a passive, kinetic energy-dissipative foundation that improves the stability in human-robot physical interaction. This foundation is realized through a Cartesian admittance with positive-definite virtual inertia and damping, ensuring that any external wrench from the human 120 produces a bounded, compliant velocity response. Since the admittance dynamics are passive by construction, the closed-loop system resists unbounded energy injection, even under abrupt or unpredictable human actions. Importantly, the stability and safety of this reactive layer are independent of any predictive or auxiliary modules, allowing the robot 130 to fall back to purely reactive compliance if necessary.

The predictive component is explicitly bounded in magnitude and blended with the reactive torque command via a tunable gain E. In this scheme, the predictive term functions only as a bounded disturbance to the passive base controller. Because its influence is both scaled and constrained, it cannot override the dissipative behavior of the admittance or destabilize the control system 200. Thus, even if the predictive term is inaccurate, due to intent misestimation, noisy data, or unforeseen changes, the robot 130 remains compliant, stable, and safe to interact with. Predictive assistance, therefore, improves performance without compromising the fundamental safety guarantees of the reactive controller.

### H. Extensions and Variants

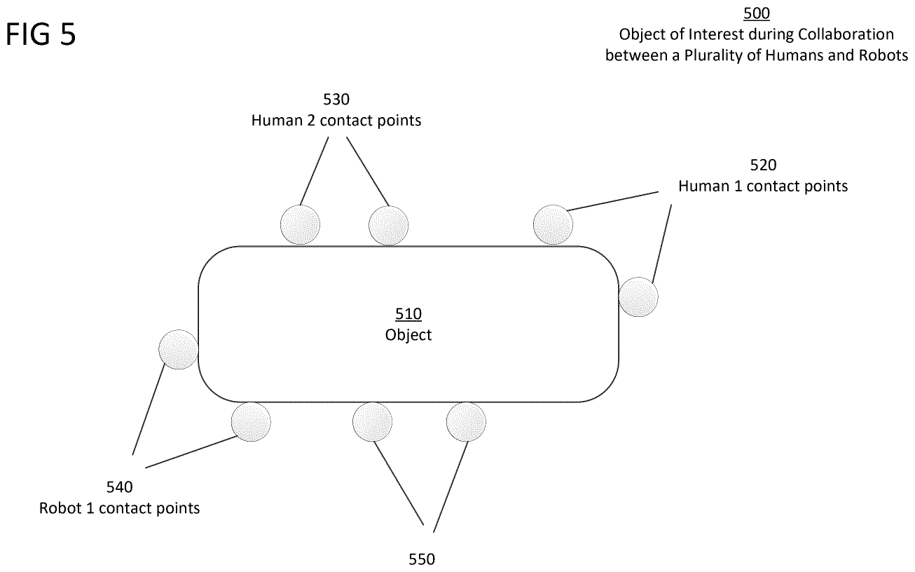

FIG. 5 illustrates an object 500 during collaboration between a plurality of humans and robots, according to aspects of the present disclosure.

While the foregoing description has focused primarily on scenarios involving a single human 120 and a single robot 130, the disclosed control architecture 200 is readily extensible to collaborative tasks involving multiple humans and multiple robots. In such cases, the contact points 520, 530, 540, 550 applied by all agents are aggregated and translated into a total wrench Wc imposed on the object 510. This total wrench inherently accounts for the contributions of each participant, whether human or robotic.

If all human collaborators are assumed to share the same underlying cost function, each robot can compute its actions locally in a manner consistent with the single-agent formulation described above. Once the intent performance function 240 has been trained, all robots can cooperate effectively to support the shared objective. During the training phase, or in situations where training is imperfect, it is possible that each robot may operate with a slightly different cost function, potentially leading to conflicting actions. To address this, training can be performed jointly by sharing historical data among the robots and training a unified intent function, thereby promoting coordinated behavior across all robots.

The control system 200 also supports a range of learning-based enhancements. Reinforcement learning (RL) provides both offline and online alternatives for developing the predictive assistance policy. Offline RL can be used to train the predictive component using recorded human-robot interaction datasets, enabling the system to learn mappings from state-force histories to effective velocity or torque commands without requiring additional physical trials. The resulting predictive policy can then be deployed in a fixed form during execution. Alternatively, online RL enables the robot to continuously update its assistance policy in real-time, using feedback from the human and the environment as reward signals. This enables adaptation to individual users or evolving task conditions. However, when applying RL online, it is essential to integrate passivity constraints or safety filters to ensure that safety and stability are maintained at all times.

The RGB-D camera offers additional opportunities for enhancement beyond basic object tracking, enabling reactive control. RGB-D data can provide richer state information for the historical state database 230, improve the accuracy of human intent inference by capturing the human's posture and motion, and enable predictive models to anticipate environmental constraints or obstacles. RGB-D data may also be leveraged offline to train the intent model, with visual context synchronized to force and motion data to develop multimodal predictors of intent. In some configurations, vision may be used solely to refine or confirm the inferred goal, without participating in reactive compliance. When combined with predefined targets, RGB-D sensing can supply the positional information needed to determine when the object is aligned with one of several possible target locations, allowing the predictive controller to adjust its assistance accordingly.

Additionally, the disclosed approach supports autonomous task completion without human intervention. By examining the estimated reward function and calculating the likelihood of each possible goal, the control system 200 can identify the most probable objective from a set of alternatives. This enables the robot to autonomously complete the task when appropriate, further enhancing the flexibility and utility of the control architecture.

### III. Computing Device

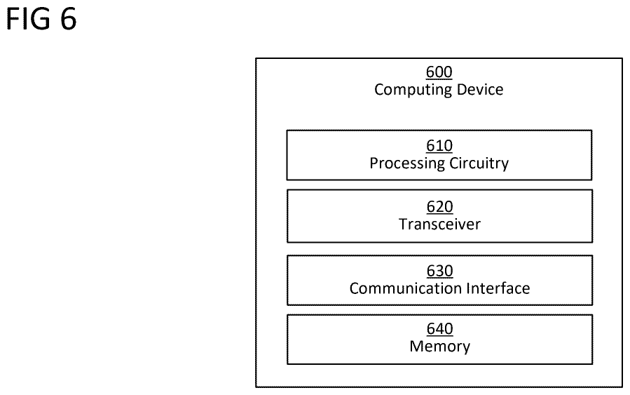

FIG. 6 illustrates a computing device 600, according to aspects of the disclosure.

The computing device 600 may be identified with a central controller and be implemented as any suitable network infrastructure component, which may be implemented as a cloud/edge network server, controller, computing device, etc. The computing device 600 may serve as a central controller for the human-robot collaboration control system 200, in accordance with the various techniques discussed herein. To do so, the computing device 600 may include processor circuitry 610, a transceiver 620, a communication interface 630, and a memory 640. The components shown in FIG. 6 are provided for ease of explanation, and the computing device 600 may implement additional, fewer, or alternative components than those shown in FIG. 6.

The processor circuitry 610 may be operable as any suitable number and/or type of computer processor that may function to control the computing device 600. The processor circuitry 610 may be identified with one or more processors (or suitable portions thereof) implemented by the computing device 600. The processor circuitry 610 may be identified with one or more processors such as a host processor, a digital signal processor, one or more microprocessors, graphics processors, baseband processors, microcontrollers, an application-specific integrated circuit (ASIC), a portion (or the entirety of) a field-programmable gate array (FPGA), etc.

In any case, the processor circuitry 610 may be operable to execute instructions to perform arithmetic, logic, and/or input/output (I/O) operations and/or to control the operation of one or more components of the computing device 600 to perform various functions as described herein. The processor circuitry 610 may include one or more microprocessor cores, memory registers, buffers, clocks, etc. It may generate electronic control signals associated with the components of the computing device 600 to control and/or modify the operation of those components. The processor circuitry 610 may communicate with and/or control functions associated with the transceiver 620, the communication interface 630, and/or the memory 640. The processor circuitry 610 may additionally perform various operations to control the communications, communications scheduling, and/or operation of other network infrastructure components communicatively coupled to the computing device 600.

The transceiver 620 may be implemented as any suitable number and/or type of components operable to transmit and/or receive data packets and/or wireless signals in accordance with any suitable number and/or type of communication protocols. The transceiver 620 may include any suitable type of components to facilitate this functionality, including components associated with known transceiver, transmitter, and/or receiver operations, configurations, and implementations. Although shown as a transceiver in FIG. 6, the transceiver 620 may include any suitable number of transmitters, receivers, or combinations thereof, which may be integrated into a single transceiver or as multiple transceivers or transceiver modules. The transceiver 620 may include components typically identified with a radio frequency (RF) front end and include, for example, antennas, ports, power amplifiers (PAS), RF filters, mixers, local oscillators (LOs), low noise amplifiers (LNAs), up-converters, down-converters, channel tuners, etc.

The communication interface 630 may be implemented as any suitable number and/or type of components operable to facilitate the transceiver 620 to receive and/or transmit data and/or signals in accordance with one or more communication protocols, as discussed herein. The communication interface 630 may be implemented as any suitable number and/or type of components operable to interface with the transceiver 620, such as analog-to-digital converters (ADCs), digital-to-analog converters, intermediate frequency (IF) amplifiers and/or filters, modulators, demodulators, baseband processors, and the like. The communication interface 630 may thus operate in conjunction with the transceiver 620 and form part of an overall communication circuitry implemented by the computing device 600, which may be implemented via the computing device 600 to transmit commands and/or control signals to perform any of the functions described herein.

The memory 640 is operable to store data and/or instructions such that when the instructions are executed by the processor circuitry 610, they cause the computing device 600 to perform various functions as described herein. The memory 640 may be implemented as any known volatile and/or non-volatile memory, including, for example, read-only memory (ROM), random access memory (RAM), flash memory, a magnetic storage medium, an optical disk, erasable programmable read-only memory (EPROM), programmable read-only memory (PROM), etc. The memory 640 may be non-removable, removable, or a combination of the two. The memory 640 may be implemented as a non-transitory computer-readable medium storing one or more executable instructions such as logic, algorithms, code, etc.

As further discussed below, the instructions, logic, code, etc., stored in the memory 640 are represented by the various modules/engines as shown in FIG. 6. Alternatively, when implemented via hardware, the modules/engines shown in FIG. 6 associated with the memory 640 may include instructions and/or code to facilitate control and/or monitoring of the operation of such hardware components. In other words, the modules/engines shown in FIG. 6 are provided to facilitate an explanation of the functional association between hardware and software components. Thus, the processor circuitry 610 may execute the instructions stored in these respective modules/engines in conjunction with one or more hardware components to perform the various functions discussed herein.

Various aspects described herein may utilize one or more machine learning models for intent inference, predictive control, and adaptation within the human-robot collaboration control system. The term “model,” as used herein, may be understood to mean any type of algorithm that provides output data from input data (e.g., any type of algorithm that generates or calculates output data from input data). A machine learning model can be executed by a computing system to progressively improve the performance of a particular task. In some aspects, the parameters of a machine learning model may be adjusted during a training phase based on training data. A trained machine learning model may be used during an inference phase to make predictions or decisions based on input data. In some aspects, the trained machine learning model may be used to generate additional training data. An additional machine learning model may be tuned during a second training phase based on the generated additional training data. A trained additional machine learning model may be used during an inference phase to make predictions or decisions based on input data.

The machine learning models described herein may take any suitable form or utilize any suitable technique (e.g., for training purposes). For example, each of the machine learning models may utilize supervised learning, semi-supervised learning, unsupervised learning, or reinforcement learning techniques.

In supervised learning, the model may be built using a training set of data that includes both the inputs and the corresponding desired outputs (illustratively, each input may be associated with a desired or expected output for that input). Each training instance may include one or more inputs and a desired output. Training may involve iterating through training instances and using an objective function to teach the model to predict the output for new inputs (illustratively, for inputs not included in the training set). In semi-supervised learning, a portion of the inputs in the training set may lack corresponding desired outputs (e.g., one or more inputs may not be associated with any desired or expected output).

In unsupervised learning, the model may be built from a training set of data that includes only inputs and no desired outputs. The unsupervised model may be used to find structure in the data (e.g., grouping or clustering of data points), for example, by discovering patterns in the data. Techniques that may be implemented in an unsupervised learning model may, for example, self-organizing maps, nearest-neighbor mapping, k-means clustering, and singular value decomposition.

Reinforcement learning models may include positive or negative feedback to improve accuracy. A reinforcement learning model may attempt to maximize one or more goals/rewards. Techniques that may be implemented in a reinforcement learning model may include, for example, Q-learning, temporal difference (TD), and deep adversarial networks.

Various aspects described herein may utilize one or more classification models. In a classification model, outputs may be restricted to a limited set of values (e.g., one or more classes). The classification model may output a class for an input set of one or more input values. An input set may include sensor data, such as image data, radar data, LIDAR (light detection and ranging) data, and the like. A classification model as described herein may, for example, classify certain driving conditions and/or environmental conditions, such as weather conditions, road conditions, and the like. References herein to classification models may contemplate a model that implements, for example, one or more of the following techniques: linear classifiers (e.g., logistic regression or naive Bayes classifier), support vector machines, decision trees, boosted trees, random forest, neural networks, or nearest neighbor.

Various aspects described herein may utilize one or more regression models. A regression model may output a numerical value from a continuous range based on an input set of one or more values (e.g., starting from or using an input set of one or more values). References herein to regression models may contemplate a model that implements, for example, one or more of the following techniques (or other suitable techniques): linear regression, decision trees, random forests, or neural networks.

A machine learning model described herein may be or include a neural network. The neural network may be any type of neural network, such as a convolutional neural network, an autoencoder network, a variational autoencoder network, a sparse autoencoder network, a recurrent neural network, a deconvolutional network, a generative adversarial network, a forward-thinking neural network, a sum-product neural network, and the like. The neural network can have any number of layers. The training of the neural network (e.g., the adaption of the layers of the neural network) may use or be based on any kind of training principle, such as backpropagation (e.g., using the backpropagation algorithm).

The aspects of the present disclosure address a need in advanced manufacturing environments for improved human-robot collaboration in tasks involving delicate, heavy, or high-value components. In particular, the disclosed systems and methods can reduce operator strain and increase throughput by enabling robots to adapt in real time to human intent while ensuring safe physical interaction. In semiconductor fabrication facilities, for example, the disclosed control architecture allows collaborative robots to support human operators in handling fragile or cumbersome objects, thereby enhancing both efficiency and safety in production processes.

The disclosed architecture maintains a passivity-based reactive backbone while introducing a parallel predictive channel. Because the reactive path remains kinetic energy-dissipative, stability is preserved even when predictive assistance is active. Assistance can be scaled through a blending factor, allowing increased support without compromising stability. As a result, the system provides the same or greater safety compared to existing approaches while reducing human effort and improving task completion times.

The predictive path learns an explicit performance function online from wrench-twist data, applies automatic differentiation to generate assistance signals in appropriate coordinates, and adapts in real time for each human. This approach avoids reliance on predefined goal graphs and instead accommodates ambiguous or changing human intent by continuously updating the objective. When explicit task goals are available, they can be integrated as priors without requiring redesign of the controller. This makes the predictive path particularly effective for highly interactive tasks.

The control system operates directly from measured contact wrenches, performs frame-consistent wrench fusion, and generates object-level twist commands that are distributed to each robotic end-effector using standard spatial transforms. Although internal force regulation may be incorporated, it is not required for basic operation, thereby reducing modeling complexity and setup time.

The disclosed pipeline links intent inference with control at the object level by combining an admittance-based reactive path with a gradient-based predictive term. Units, frames, and passivity are maintained consistently throughout, resulting in behavior that is interpretable, tunable, and suitable for formal safety evaluation.

Learning is confined to the intent model, while the plant-side controller remains classical and passive. This separation improves sample efficiency, provides inherent stability, and simplifies validation. When offline data are available, the intent model can be pretrained; during online operation, adaptation proceeds cautiously while the reactive path constrains energy injection.

A distinctive aspect of the disclosed control architecture is the integration of a passive reactive path with a bounded, continuously adapting predictive path operating in the wrench-twist domain. This configuration retains the inherent stability and compliance of admittance control while enabling real-time intent inference and proactive task assistance without requiring prior object models, pre-segmented demonstrations, or fixed goal assumptions. By limiting learning to the intent model and grounding the physical interaction loop in passivity, the disclosed architecture uniquely provides online adaptability, multi-gripper coordination, and predictive capability in a form that is interpretable, tunable, and certifiably safe-capabilities not simultaneously achieved in prior reactive, predictive, multi-arm, or learning-based approaches.

The techniques described in this disclosure may also be illustrated in the following examples.

Example 1. A control system for human-robot collaboration, comprising: a passive reactive control path implemented through a virtual damping system and configured to generate reactive control signals in response to human-applied interaction inputs; a predictive control path configured to generate predictive control signals based on predicted human performance objective inferred online from measured contact wrenches; and a signal blending component configured to combine the reactive control signals and the predictive control signals, wherein the predictive control signals are bounded in magnitude such that passivity of the reactive control path is preserved and stability of closed-loop human-robot interaction is maintained during collaboration.

Example 2. The control system of example 1, wherein the passive reactive control path is configured to dissipate kinetic energy.

Example 3. The control system of any one or more of examples 1-2, wherein the predictive control path comprises an intent performance function configured to infer the predicted human performance objective derived online from measured contact wrenches and object state histories stored in a historical database.

Example 4. The control system of any one or more of examples 1-3, wherein the predictive control signals bound disturbances to the reactive control signals, such that the reactive control path remains passive and the closed-loop human-robot interaction remains stable.

Example 5. The control system of any one or more of examples 1-4, wherein the control system operates in a wrench-twist coordinate system at an object level, mapping contact wrenches to object twists.

Example 6. The control system of any one or more of examples 1-5, wherein the virtual damping system is configured to perform frame-consistent fusion of wrenches from a plurality of grippers into a fused contact wrench, and to map the fused contact wrench into object-level twist commands.

Example 7. The control system of any one or more of examples 1-6, wherein the predictive control path comprises a predictive controller configured to generate predictive control signals by optimizing a performance function representing the human performance objective, and wherein the performance function is continuously updated online.

Example 8. The control system of any one or more of examples 1-7, wherein the performance function is parameterized by a neural network, and neural network parameters are continuously adapted using gradient-based optimization on prediction errors derived from human interaction data.

Example 9. The control system of any one or more of examples 1-8, wherein the predictive control path comprises a predictive controller configured to generate the predictive control signals by performing gradient ascent on a performance function learned through parameter adaptation to improve task performance from a perspective of the human.

Example 10. The control system of any one or more of examples 1-9, wherein the signal blending component is configured to apply a scaling factor to constrain the predictive control signals relative to the reactive control signals.

Example 11. The control system of any one or more of examples 1-10, wherein the control system is configured to coordinate collaboration among multiple agents.

Example 12. The control system of any one or more of examples 1-11, wherein the intent performance function is configured to determine a probable human performance objective from a plurality of human performance objectives by evaluating likelihoods based on the intent performance function, and the predictive control path further comprises a predictive controller configured to generate control signals to complete an inferred task objective autonomously.

Example 13. A non-transitory computer-readable medium comprising instructions that, when executed by a processor of a human-robot collaboration control system, cause the processor to: generate, via a passive reactive control path implemented through a virtual damping system, reactive control signals in response to human-applied interaction inputs; generate, via a predictive control path, predictive control signals based on predicted human performance objective inferred online from measured contact wrenches; and combine the reactive control signals and the predictive control signals, wherein the predictive control signals are bounded in magnitude such that passivity of the reactive control path is preserved and stability of closed-loop human-robot interaction is maintained during collaboration.

Example 14. The non-transitory computer-readable medium of example 13, wherein the instructions further cause the processor to: implement an intent performance function configured to infer the predicted human performance objective derived online from measured contact wrenches and object state histories stored in a historical database.

Example 15. The non-transitory computer-readable medium of any one or more of examples 13-14, wherein the instructions further cause the processor to: generate predictive control signals that function as bounded disturbances to reactive control signals, such that the reactive control path remains passive and closed-loop human-robot interaction remains stable.

Example 16. The non-transitory computer-readable medium of any one or more of examples 13-15, wherein the instructions further cause the processor to: operate the control system in a wrench-twist coordinate system at an object level, mapping contact wrenches to object twists.

Example 17. The non-transitory computer-readable medium of any one or more of examples 13-16, wherein the instructions further cause the processor to: perform frame-consistent fusion of wrenches from a plurality of grippers into a fused contact wrench, and map the fused contact wrench into object-level twist commands.

Example 18. The non-transitory computer-readable medium of any one or more of examples 13-17, wherein the instructions further cause the processor to: generate predictive control signals by optimizing a performance function representing the human performance objective, wherein the performance function is continuously updated online.

Example 19. The non-transitory computer-readable medium of any one or more of examples 13-18, wherein the instructions further cause the processor to: implement the performance function parameterized by a neural network, wherein neural network parameters are continuously adapted using gradient-based optimization on prediction errors derived from human interaction data.

Example 20. The non-transitory computer-readable medium of any one or more of examples 13-19, wherein the instructions further cause the processor to: configure the intent performance function to determine a probable human performance objective from a plurality of human performance objectives by evaluating likelihoods, and generate control signals to complete an inferred task objective autonomously.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. A control system for human-robot collaboration, comprising:
a passive reactive control path implemented through a virtual damping system and configured to generate reactive control signals in response to human-applied interaction inputs;
a predictive control path configured to generate predictive control signals based on predicted human performance objective inferred online from measured contact wrenches; and
a signal blending component configured to combine the reactive control signals and the predictive control signals, wherein the predictive control signals are bounded in magnitude such that passivity of the reactive control path is preserved and stability of closed-loop human-robot interaction is maintained during collaboration.

2. The control system of claim 1, wherein the passive reactive control path is configured to dissipate kinetic energy.

3. The control system of claim 1, wherein the predictive control path comprises an intent performance function configured to infer the predicted human performance objective derived online from measured contact wrenches and object state histories stored in a historical database.

4. The control system of claim 3, wherein the predictive control signals bound disturbances to the reactive control signals, such that the reactive control path remains passive and the closed-loop human-robot interaction remains stable.

5. The control system of claim 1, wherein the control system operates in a wrench-twist coordinate system at an object level, mapping contact wrenches to object twists.

6. The control system of claim 5, wherein the virtual damping system is configured to perform frame-consistent fusion of wrenches from a plurality of grippers into a fused contact wrench, and to map the fused contact wrench into object-level twist commands.

7. The control system of claim 3, wherein the predictive control path comprises a predictive controller configured to generate predictive control signals by optimizing a performance function representing the human performance objective, and wherein the performance function is continuously updated online.

8. The control system of claim 7, wherein the performance function is parameterized by a neural network, and neural network parameters are continuously adapted using gradient-based optimization on prediction errors derived from human interaction data.

9. The control system of claim 3, wherein the predictive control path comprises a predictive controller configured to generate the predictive control signals by performing gradient ascent on a performance function learned through parameter adaptation to improve task performance from a perspective of the human.

10. The control system of claim 1, wherein the signal blending component is configured to apply a scaling factor to constrain the predictive control signals relative to the reactive control signals.

11. The control system of claim 1, wherein the control system is configured to coordinate collaboration among multiple agents.

12. The control system of claim 3, wherein the intent performance function is configured to determine a probable human performance objective from a plurality of human performance objectives by evaluating likelihoods based on the intent performance function, and the predictive control path further comprises a predictive controller configured to generate control signals to complete an inferred task objective autonomously.

13. A non-transitory computer-readable medium comprising instructions that, when executed by a processor of a human-robot collaboration control system, cause the processor to:
generate, via a passive reactive control path implemented through a virtual damping system, reactive control signals in response to human-applied interaction inputs;
generate, via a predictive control path, predictive control signals based on predicted human performance objective inferred online from measured contact wrenches; and
combine the reactive control signals and the predictive control signals, wherein the predictive control signals are bounded in magnitude such that passivity of the reactive control path is preserved and stability of closed-loop human-robot interaction is maintained during collaboration.

14. The non-transitory computer-readable medium of claim 13, wherein the instructions further cause the processor to:
implement an intent performance function configured to infer the predicted human performance objective derived online from measured contact wrenches and object state histories stored in a historical database.

15. The non-transitory computer-readable medium of claim 14, wherein the instructions further cause the processor to:
generate predictive control signals that function as bounded disturbances to reactive control signals, such that the reactive control path remains passive and closed-loop human-robot interaction remains stable.

16. The non-transitory computer-readable medium of claim 13, wherein the instructions further cause the processor to:
operate the control system in a wrench-twist coordinate system at an object level, mapping contact wrenches to object twists.

17. The non-transitory computer-readable medium of claim 16, wherein the instructions further cause the processor to:
perform frame-consistent fusion of wrenches from a plurality of grippers into a fused contact wrench, and map the fused contact wrench into object-level twist commands.

18. The non-transitory computer-readable medium of claim 14, wherein the instructions further cause the processor to:
generate predictive control signals by optimizing a performance function representing the human performance objective, wherein the performance function is continuously updated online.

19. The non-transitory computer-readable medium of claim 18, wherein the instructions further cause the processor to:
implement the performance function parameterized by a neural network, wherein neural network parameters are continuously adapted using gradient-based optimization on prediction errors derived from human interaction data.

20. The non-transitory computer-readable medium of claim 14, wherein the instructions further cause the processor to:
configure the intent performance function to determine a probable human performance objective from a plurality of human performance objectives by evaluating likelihoods, and generate control signals to complete an inferred task objective autonomously.
